(19) United States
(12) Patent Application Publication
(10) Pub. No.: US 2016/0170108 A1
(43) Pub. Date: Jun. 16, 2016

(54) OPTICAL FILTER

(71) Applicant: Sharp Kabushiki Kaisha, Osaka (JP)

(72) Inventors: Suguru Kawabata, Osaka-shi (JP); Takashi Nakano, Osaka-shi (JP); Kazuhiro Natsuaki, Osaka-shi (JP); Masaaki Uchihashi, Osaka-shi (JP); Masayo Uchida, Osaka-shi (JP)

(21) Appl. No.: 14/965,628

(22) Filed: Dec. 10, 2015

(30) Foreign Application Priority Data
Dec. 11, 2014 (JP) 2014-250593

(51) Int. Cl. G02B 5/28; G02B 5/00

(52) U.S. Cl. CPC G02B 5/288; G02B 5/008

(57) ABSTRACT

An optical filter is provided. The optical filter includes a plurality of metal layers, and a dielectric body layer disposed between two adjacent metal layers of the plurality of metal layers. Each of the plurality of metal layers is formed with a plurality of slits, and the plurality of slits formed in one of the adjacent metal layers do not overlap with the plurality of slits formed in the other of the adjacent metal layers in a normal direction of the adjacent metal layers.

### BACKGROUND

The present invention relates to an optical filter, specifically to an optical filter of a slit type, which includes a metal layer where slits are formed at a predetermined cycle, and mainly transmits light of a predetermined wavelength range.

Recently, optical filters which mainly transmit light of a predetermined wavelength range through a metal layer formed with openings at a predetermined cycle have been proposed. Such optical filters can be differentiated into a hole type and a slit type based on the shape of their openings.

The optical filter of the hole type has higher transmissivity than the optical filter of the slit type. However, in a case where the optical filter of the hole type is made to function as an edge filter or a band-pass filter, an issue that a transmission wavelength range (sub-peak) unintentionally appears near a selected wavelength range (predetermined wavelength range), a so-called sub-peak issue, needs to be solved. In JP2010-160212A, such an issue is dealt with by considering the sub-peak as one waveguide mode and complicating the structure of the optical filter.

With the optical filter of the slit type, it is difficult to transmit a polarization element in parallel to a direction in which the slits extend. Therefore, the transmissivity thereof is lower than the optical filter of the hole type. However, by suitably adjusting an aperture ratio, cycle, etc., of the slits, the sub-peak can sufficiently be separated from a selected wavelength. Therefore, it is easier to simplify the structure of the optical filter of the slit type than the optical filter of the hole type. Considering the manufacturing process of the optical filter, selecting the slit type has more merits. The optical filter of the slit type is disclosed in JP2013-525863A, JP2013-522235A, JP2012-242387A, and T. Xu, et al., Nature Communications 1:59 DOI:10.1038/ncomms1058 (2010), for example.

### SUMMARY

The present invention aims to improve transmissivity of light of a predetermined wavelength range in an optical filter of a slit type which has a simple structure, the optical filter including a metal layer formed with slits at a predetermined cycle, and mainly transmitting light of a predetermined wavelength range.

According to an aspect of the present invention, an optical filter is provided. The optical filter includes a plurality of metal layers, and a dielectric body layer disposed between two adjacent metal layers of the plurality of metal layers. Each of the plurality of metal layers is formed with a plurality of slits at an even interval in a predetermined direction, and the plurality of slits formed in one of the adjacent metal layers do not overlap with the plurality of slits formed in the other metal layer in a normal direction of the adjacent metal layers.

Although the optical filter according to the aspect of the present invention has a simple structure, transmissivity of light of a predetermined wavelength range improves. In other words, high transmissivity and a property of mainly transmitting light of the predetermined wavelength range (wavelength selectivity) can both be achieved. As a result, the optical filter can function as a band-pass filter.

### BRIEF DESCRIPTION OF THE DRAWINGS

FIG. 1 is a perspective view illustrating a schematic configuration of an optical filter according to a first embodiment of the present invention.

FIG. 2 is a chart illustrating a transmission property of the optical filter of FIG. 1.

FIG. 3A is a chart illustrating a relationship of a difference between a cycle and a width of a slit with a selected wavelength, and FIG. 3B is a chart illustrating a relationship between a thickness of a dielectric body layer and the selected wavelength.

FIG. 4 is a plan view illustrating a schematic configuration of an optical filter according to a second embodiment of the present invention.

FIG. 5 is a chart illustrating a transmission property of the optical filter of FIG. 1 when the difference between the cycle and the width of the slit is 970 nm.

FIG. 6 is a chart illustrating a wavelength range detectable by one optical filter but not detectable by another optical filter.

FIG. 7 is a perspective view illustrating a schematic configuration of an optical filter according to a third embodiment of the present invention.

FIG. 8 is a chart illustrating a transmission property of the optical filter of FIG. 7.

FIG. 9 is a chart illustrating a sensitivity property of the optical filter of FIG. 7 when the optical filter is disposed on a charge-coupled device (CCD) image sensor and a black filter is disposed on the optical filter of FIG. 7.

FIG. 10 is a perspective view illustrating a schematic configuration of an optical filter according to a fourth embodiment of the present invention.

FIG. 11 is a chart illustrating transmission properties, in which the transmission property of the optical filter of FIG. 10 is indicated by a solid line and the transmission properties of an optical filter in which upper slits and lower slits are formed at the same cycle as each other are indicated by dashed lines.

FIG. 12A is a view illustrating a magnetic field distribution in the optical filter of FIG. 10 in a steady state when light having a wavelength of 1,500 nm enters, FIG. 12B is a view illustrating a magnetic field distribution in the optical filter of FIG. 10 in the steady state when light having a wavelength of 2,500 nm enters, FIG. 12C is a view illustrating a magnetic field distribution in an optical filter of Mode (1) in the steady state when light having a wavelength of around 1,500 nm enters, FIG. 12D is a view illustrating a magnetic field distribution in the optical filter of Mode (1) in the steady state when light having a wavelength of around 2,500 nm enters, FIG. 12E is a view illustrating a magnetic field distribution in an optical filter of Mode (2) in the steady state when light having a wavelength of around 2,500 nm enters, and FIG. 12F is a view illustrating a magnetic field distribution in the optical filter of Mode (2) in the steady state when light having a wavelength of around 4,500 nm enters.

FIG. 13A is a view illustrating an electric field distribution in the optical filter of FIG. 10 in the steady state when light having a wavelength of 2,500 nm enters, FIG. 13B is a view illustrating an electric field distribution in the optical filter of Mode (1) in the steady state when light having a wavelength of around 2,500 nm enters, and FIG. 13C is a view illustrating an electric field distribution in the optical filter of Mode (2) in the steady state when light having a wavelength of around 2,500 nm enters.

FIG. 14 is a perspective view illustrating a schematic configuration of an optical filter according to a modification of the fourth embodiment of the present invention.

FIG. 15 is a chart illustrating a transmission property of the optical filter of FIG. 14 and the transmission property of the optical filter of FIG. 10.

FIG. 16 is a chart illustrating a difference in the transmission property when a refractive index of the dielectric body layer is changed.

FIG. 17 is a perspective view illustrating a schematic configuration of an optical filter according to a sixth embodiment of the present invention.

FIG. 18 is a chart illustrating a transmission property of the optical filter of FIG. 17 and a transmission property of an optical filter having a configuration without a metal layer which is provided as a topmost layer of the optical filter of FIG. 17.

FIG. 19 is a perspective view illustrating a schematic configuration of an optical filter of a slit type according to a reference example.

FIG. 20 is a chart illustrating a relationship of a difference between a cycle and a width of the slit with a wavelength of light to be transmitted by a band-pass filter according to the reference example.

FIG. 21 is a chart illustrating a result obtained by examining a relationship between a transmissivity and a wavelength by setting the difference between the cycle and the width of the slit at 2,320 nm, according to the reference example.

FIG. 22 is a chart illustrating a relationship between the width and a half width of the slit, and a relationship between the width of the slit and the transmissivity, according to the reference example.

FIG. 23 is a chart illustrating a result obtained by examining transmissivity of light of a mid-infrared range, according to the reference example.

FIG. 24A is a chart illustrating an electric field distribution in the steady state with 2,200 nm which is at an edge according to the reference example, and FIG. 24B is a chart illustrating an electric field distribution in the steady state with 4,000 nm which is far from the edge according to the reference example.

FIG. 25 is a chart illustrating a result obtained by examining the relationship between the wavelength and the transmissivity with a structure in which a plurality of slits formed in one metal layer do not overlap with a plurality of slits formed in another metal layer when seen from a normal direction of the metal layers, according to the reference example.

### DETAILED DESCRIPTION OF EMBODIMENTS

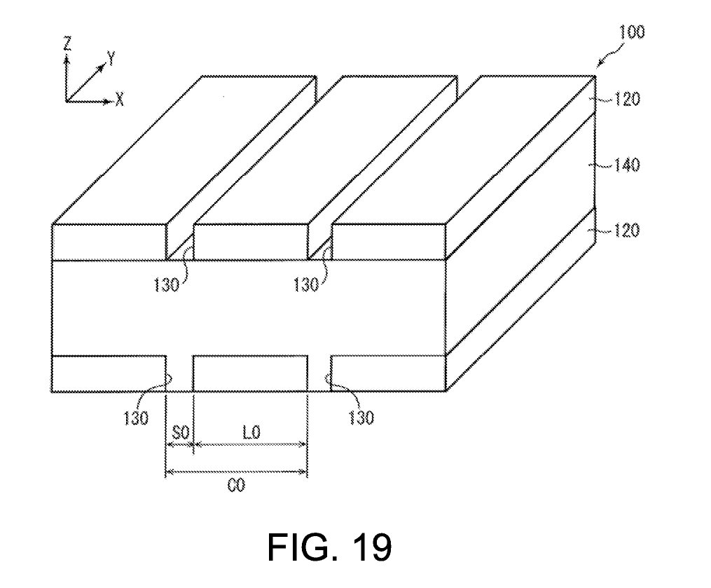

The present inventors have studied an issue caused when an optical filter 100 of a slit type illustrated in FIG. 19 is used for a band-pass filter. As a result, they have gained the following knowledge.

The band-pass filter transmits light absorbable by CO₂. The light absorption by CO₂ occurs due to the O═C═O bond. A wavelength of light absorbable by CO₂ is around a range between 4,200 nm and 4,300 nm. In the following description, such a wavelength is referred to as the CO₂ absorption wavelength.

First, a structure of the optical filter 100 is briefly described. The optical filter 100 includes two metal layers 120 and one dielectric body layer 140. Each of the metal layers 120 is formed with a plurality of slits 130 at an even interval. When seen in a normal direction of the metal layer 120 (a Z-direction of FIG. 19), the slits 130 formed in one of the metal layers 120 are formed at the same positions in an X-direction of FIG. 19 as the slits 130 formed in the other metal layer 120. In other words, when seen in the normal direction of the metal layer 120, the slits 130 formed in the one of the metal layers 120 overlap with the slits 130 formed in the other metal layer 120.

The present inventors examined properties of the optical filter 100 by the Finite-Difference Time-Domain method (FDTD method). The result is as follows.

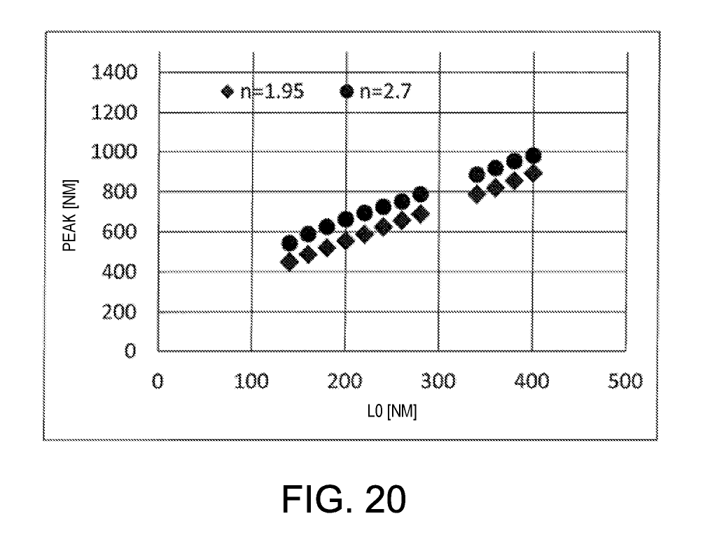

First, a relationship of a difference L0 between a cycle C0 of the slit 130 and a width S0 of the slit 130 with a wavelength of light to be transmitted by the band-pass filter (hereinafter, referred to as the selected wavelength) is examined. The result is illustrated in FIG. 20. Note that in the examination, the width S0 was set to 100 nm.

As illustrated in FIG. 20, it was found that the difference L0 is in proportion to the selected wavelength. Based on this proportional relationship, the difference L0 with which the selected wavelength becomes a wavelength around 4,200 nm was calculated. The wavelength around 4,200 nm is the CO₂ absorption wavelength. As a result, it was found that the difference L0 is required to be 2,000 nm or longer even when a dielectric body with a comparatively high refractive index, such as oxidized titanium (n=about 2.7), is used.

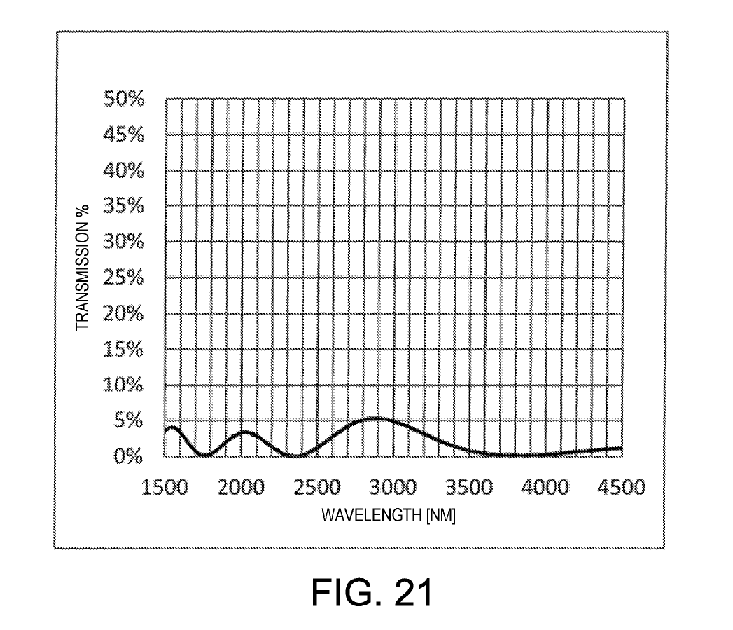

Thus, under a condition that the difference L0 is 2,320 nm, a relationship between transmissivity and wavelength was examined. The result is illustrated in FIG. 21.

As illustrated in FIG. 21, it was found that in the optical filter 100, transmissivity of light having a wavelength of an infrared range, specifically a wavelength between 2,700 nm and 3,200 nm, is insufficient. Therefore, it was found that in a case where a wavelength of the infrared range is used as the selected wavelength in the optical filter 100, the transmissivity of light having the wavelength of the infrared range needs to be improved.

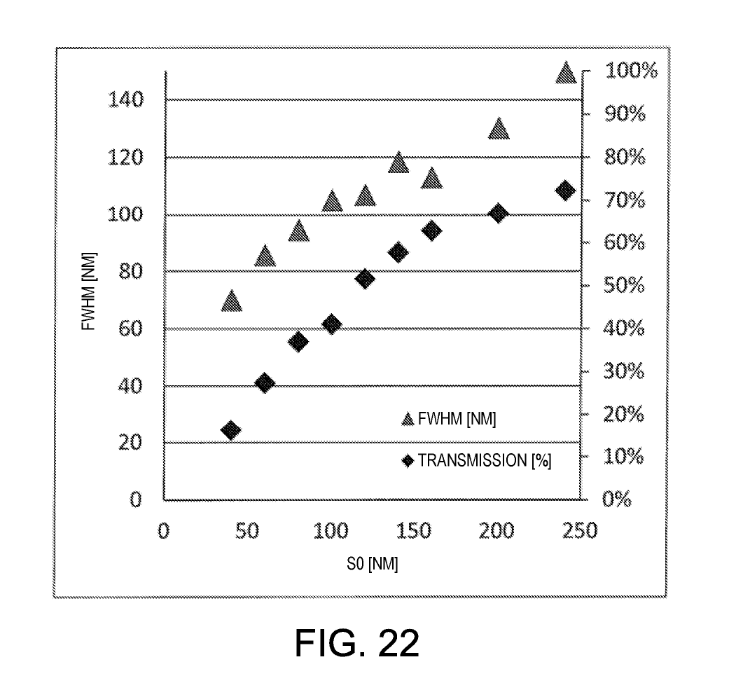

Here, if the difference L0 is increased, the transmissivity decreases. On the other hand, if the width S0 is extended, the transmissivity increases. However, as illustrated in FIG. 22, if the width S0 is simply extended, a half width (FWHM) becomes wider, causing lower selectivity of the wavelength.

Thus, the present inventors gained knowledge that in order to achieve a band-pass filter for transmitting light having the CO₂ absorption wavelength, it is difficult to apply a resonance phenomenon which is used within a conventional visible light range as is.

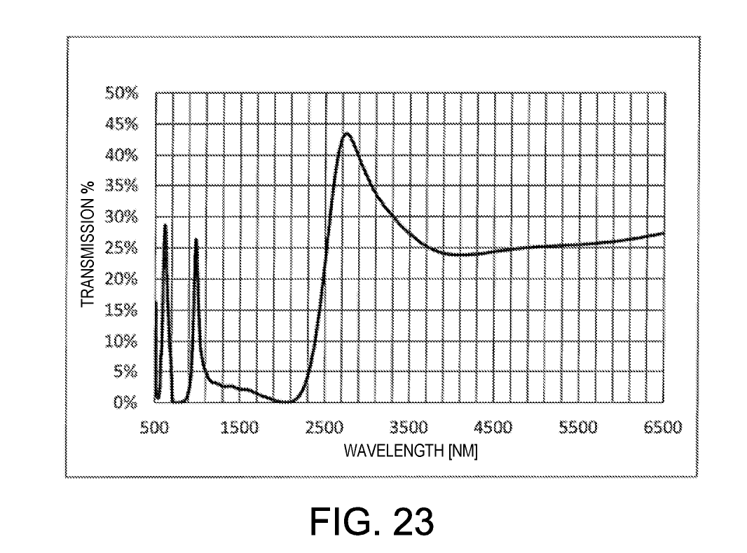

FIG. 23 illustrates a result obtained by examining transmissivity of light within a mid-infrared range (between 2,000 nm and 6,500 nm). In this examination, the difference L0 is 400 nm, the width S0 is 100 nm, the thickness of the metal layer 120 is 40 nm, and the thickness of the dielectric body layer 140 is 100 nm. As illustrated in FIG. 23, it was found that the optical filter 100 becomes a long wavelength pass filter (LWPF) having an edge within the mid-infrared range. However, this property is not sufficient for the optical filter 100 to function as the band-pass filter. It is necessary to devise the optical filter 100 such that the optical filter 100 prevents light having a wavelength longer than a required wavelength from being transmitted.

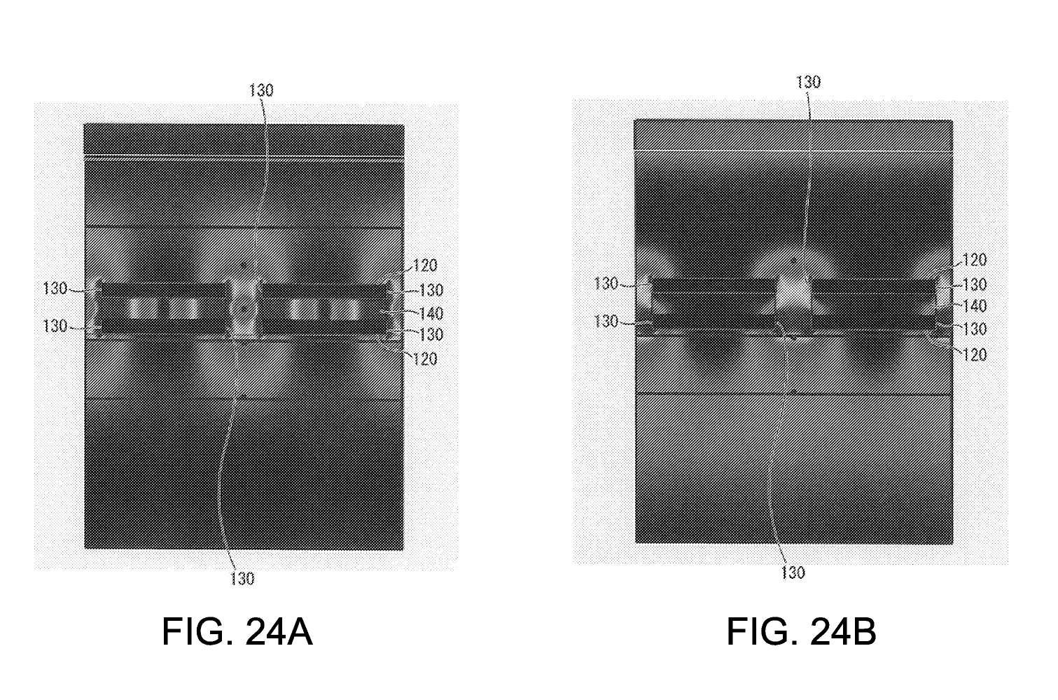

Therefore, electric and magnetic field distributions within the mid-infrared range were analyzed. FIG. 24A illustrates an electric field distribution in a steady state with 2,200 nm which is the edge. FIG. 24B illustrates an electric field distribution in the steady state with 4,000 nm which is far from the edge.

As illustrated in FIG. 24A, with 2,200 nm which is the edge, a vertically symmetric electric field distribution occurred at a boundary between one of the metal layers 120 and the dielectric body layer 140 and at a boundary between the other metal layer 120 and the dielectric body layer 140. Such an electric field distribution can be seen when resonance occurs therebetween. On the other hand, as illustrated in FIG. 24B, with 4,000 nm which is far from the edge, a vertically asymmetric electric field distribution occurred at the boundary between the one of the metal layers 120 and the dielectric body layer 140 and at the boundary between the other metal layer 120 and the dielectric body layer 140. The electric field inside the dielectric body layer 140 was explicitly smaller than with 2,200 nm which is at the edge.

Based on these results, near the edge, it can be assumed that a phenomenon similar to resonance within the visible light range, in other words, a propagation phenomenon through the boundary between the one of the metal layers 120 and the dielectric body layer 140 and the boundary between the other metal layer 120 and the dielectric body layer 140 occurred. On the other hand, within the wavelength range far from the edge, it can be assumed that a propagation of light by a phenomenon other than the propagation phenomenon described above, for example, a transmission phenomenon through a side surface of the optical filter, occurred.

In the case of the propagation phenomenon described above, even if the slits 130 formed in one of the metal layers 120 are shifted in the X-direction (see FIG. 19) to offset from the slits 130 formed in the other metal layer 120, substantially the same transmission property as the case where the slits 130 are not shifted is assumed to be obtained. When the slits 130 formed in the one of the metal layers 120 are shifted to offset from the slits 130 formed in the other metal layer 120, the propagation of light by a phenomenon other than the propagation phenomenon described above, particularly the transmission phenomenon through the side surface, is assumed to be suppressed.

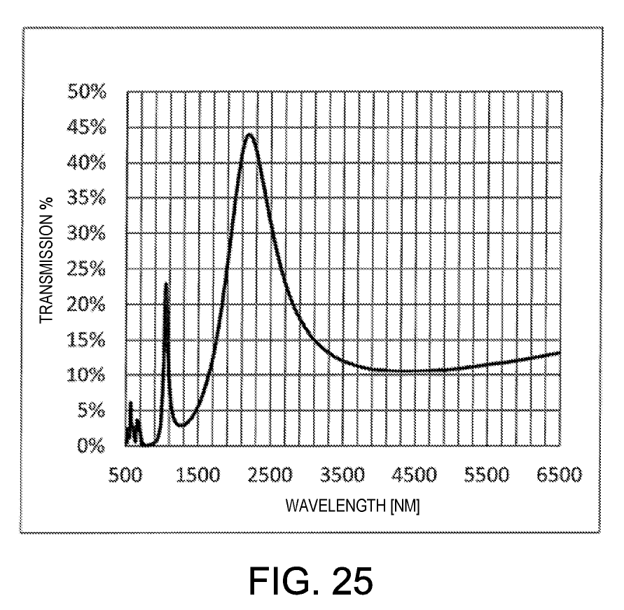

Under such assumptions, the relationship between the wavelength and the transmissivity was examined with a structure in which the slits 130 formed in the one metal layer 120 are shifted in the X-direction (see FIG. 19) to be offset from the slits 130 formed in the other metal layer 120. The result is illustrated in FIG. 25. Note that in this examination, the shifted length in the X-direction (see FIG. 19) was 200 nm.

As illustrated in FIG. 25, within a wavelength range of 2,500 nm or longer, the transmissivity of light could significantly be decreased. In other words, the property as the band-pass filter could be obtained. Based on such knowledge, the present inventors have achieved the present invention.

Hereinafter, specific embodiments of the present invention are described with reference to the appended drawings. The same/corresponding parts (layers, slits, dimensions, etc.) are denoted with the same reference character in the drawings and the description thereof is not repeatedly provided.

### First Embodiment

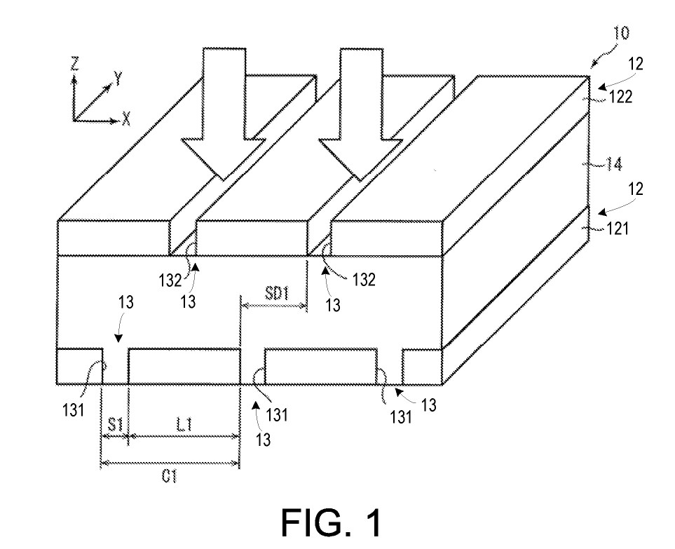

FIG. 1 is a perspective view illustrating a schematic configuration of an optical filter 10 according to a first embodiment of the present invention. Note that the arrows in FIG. 1 indicate an entering direction of light.

The optical filter 10 functions as a band-pass filter. Specifically, the optical filter 10 transmits light having the CO₂ absorption wavelength described above. The optical filter 10 is disposed, for example, in a light receiving part of a thermopile.

As illustrated in FIG. 1, the optical filter 10 includes two metal layers 12 and one dielectric body layer 14. Note that in FIG. 1, a width direction of each of the layers 12 and 14 is an X-direction, a length direction thereof is a Y-direction, and a thickness direction (normal direction) thereof is a Z-direction.

One of the two metal layers 12 (hereinafter, referred to as the metal layer 121) is formed on a supporting substrate (not illustrated). The supporting substrate includes a base layer and a base substrate. The base layer is, for example, a silicon oxidative film. The base substrate is, for example, a silicon substrate.

The other metal layer 12 (hereinafter, referred to as the metal layer 122) is disposed separated from the metal layer 121. The metal layer 122 is located on the entrance side of light with respect to the metal layer 121.

Each metal layer 12 is made from AlCu. The metal layer 12 may be made from Ag, Au, Pt, Ti, TiN, Cu, Al, etc. Within the visible light range, a refractive index of the metal layer 12 is preferably between 0.35 and 4.0. In this embodiment, the refractive index of the metal layer 12 for light having a wavelength of 550 nm is 0.74. The thickness of the metal layer 12 is, for the sake of convenience in processing, preferably between 20 nm and 100 nm. In this embodiment, the thickness of the metal layer 12 is 40 nm. The two metal layers 12 may have the same thickness or different thicknesses. In this embodiment, the two metal layers 12 have the same thickness.

Each metal layer 12 is formed with a plurality of slits 13. The plurality of slits 13 are formed at an even interval in a predetermined direction (the X-direction, in other words, the width direction of the metal layer 12 in the example of FIG. 1). A cycle C1 at which the plurality of slits 13 are formed is preferably between 900 nm and 1,500 nm. In this embodiment, the cycle C1 is 1,120 nm.

Here, the slits 13 formed in the metal layer 121 (hereinafter, referred to as the slits 131) do not overlap with the slits 13 formed in the metal layer 122 (hereinafter, referred to as the slits 132) when seen from the normal direction of the metal layer 121 (the Z-direction in FIG. 1). In the example of FIG. 1, an offset width SD1 of each slit 132 from the corresponding slit 131 is preferably between 400 nm and 700 nm. In this embodiment, the offset width SD1 is 460 nm.

A width S1 of the slit 13 is preferably between 80 nm and 200 nm. In this embodiment, the width S1 is 100 nm. The width S1 is preferably between 5% and 15% of the cycle C1. In this embodiment, the width S1 is approximately 9% of the cycle C1. In the example of FIG. 1, the width S1 of the slit 13 is fixed over the entire length of the slit 13 (the Y-direction in FIG. 1). Note that in a strict sense, the width S1 of the slit 13 may vary along the entire length of the slit 13. In the example of FIG. 1, the slits 13 have the same width S1 as each other along their entire length.

The length (in the Y-direction in FIG. 1) of the slit 13 is the same as the length (in the Y-direction in FIG. 1) of the metal layer 12. In other words, in the example of FIG. 1, the slit 13 is formed over the entire length of the metal layer 12. Note that the slit 13 may not be formed over the entire length of the metal layer 12. In the example of FIG. 1, each slit 13 has the same length.

The length of the slit 13 is preferably at least 10 times the difference L1 between the cycle C1 and the width S1. Thus, sufficient transmissivity can be secured.

The dielectric body layer 14 is formed to be in contact with the metal layer 12. Part of the dielectric body layer 14 is located within the slits 13 (131). The dielectric body layer 14 is made from SiN. Note that the dielectric body layer 14 may be made from ZnSe, SiO2, MgF, etc. A thickness of the dielectric body layer 14 is preferably between 40 nm and 200 nm. In this embodiment, the thickness of the dielectric body layer 14 is 139 nm. The thickness of the dielectric body layer 14 is preferably between 1 and 5 times the thickness of the metal layer 12. In this embodiment, the thickness of the dielectric body layer 14 is approximately 3.5 times the thickness of the metal layer 12. The refractive index of the dielectric body layer 14 is preferably 1.4 or higher within a near-infrared range, and more preferably between 1.4 and 3.0. In this embodiment, the refractive index of the dielectric body layer 14 is 2.7.

Next, a manufacturing method of the optical filter 10 is described.

First, a metal layer material is formed on the supporting substrate by sputtering. Next, by the photolithography method, patterning is performed on the metal layer material to form the metal layer 121. Then, by the CVD method, the dielectric body layer 14 is formed on the metal layer 121. If necessary, the dielectric body layer 14 may be flattened. Next, a metal layer material is formed on the dielectric body layer 14 by sputtering. Then, by the photolithography method, patterning is performed on the metal layer material to form the metal layer 122. Thus, the optical filter 10 is created. Note that for a metal layer material on which patterning by the general photolithography method is difficult, the slits are formed by a suitable process, such as mask evaporation and lift-off.

Note that the metal layer 122 may be covered by a dielectric body layer. A side surface of each metal layer 12 may be covered by a dielectric body layer. In this case, the dielectric body layer covering the side surface of the metal layer 121 may be part of the dielectric body layer 14. The side surface of each metal layer 12 may be in contact with one of air and a vacuum. The air may be in contact with the side surface of the metal layer 12 when the side surface of the metal layer 12 is not covered by the dielectric body layer, or the air may be air within a void of the dielectric body layer when the side surface of the metal layer 12 is covered by the dielectric body layer.

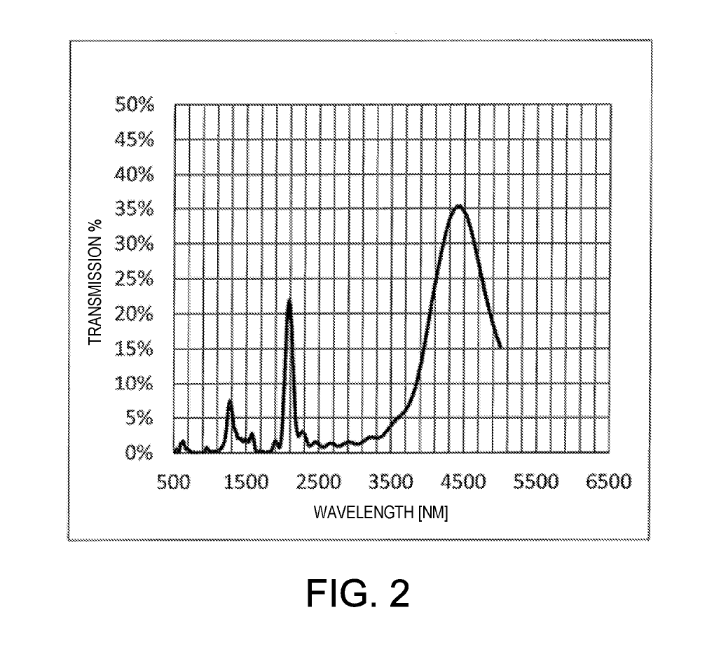

Properties of the optical filter 10 were examined by the FDTD method. The result is illustrated in FIG. 2. The examination was performed in a case where the number of slits 13 formed in each metal layer 12 was ten. A length in the thickness direction of one side of the optical filter 10 was approximately 10 μm. As illustrated in FIG. 2, the optical filter 10 transmitted light having the CO₂ absorption wavelength.

As illustrated in FIG. 2, the optical filter 10 transmitted light having a wavelength of around 2,000 nm. Note that the CO₂ absorption wavelength also exists around 2,000 nm in addition to around the range between 4,200 nm and 4,300 nm. Since the optical filter 10 can detect light having the wavelength around 2,000 nm, it can be used as a highly accurate carbon dioxide sensor.

The optical filter 10 utilizes the phenomenon similar to the resonance phenomenon at a boundary between the metal layer 12 and the dielectric body layer 14. Therefore, by optimization of parameters regarding the phenomenon (e.g., the thicknesses of the metal layers 12, the thickness of the dielectric body layer 14, etc.), the properties of the optical filter 10 can further be improved.

Here, it is necessary to change the thicknesses of the metal layers 12 and the dielectric body layer 14, the width S1, and the cycle C1 of the slit 13 according to the properties (especially the refractive index) of the materials forming the respective layers 12 and 14, and the selected wavelength. In particular, the refractive index is preferably calculated for every selected wavelength through simulations beforehand since the refractive index is wavelength-dependent.

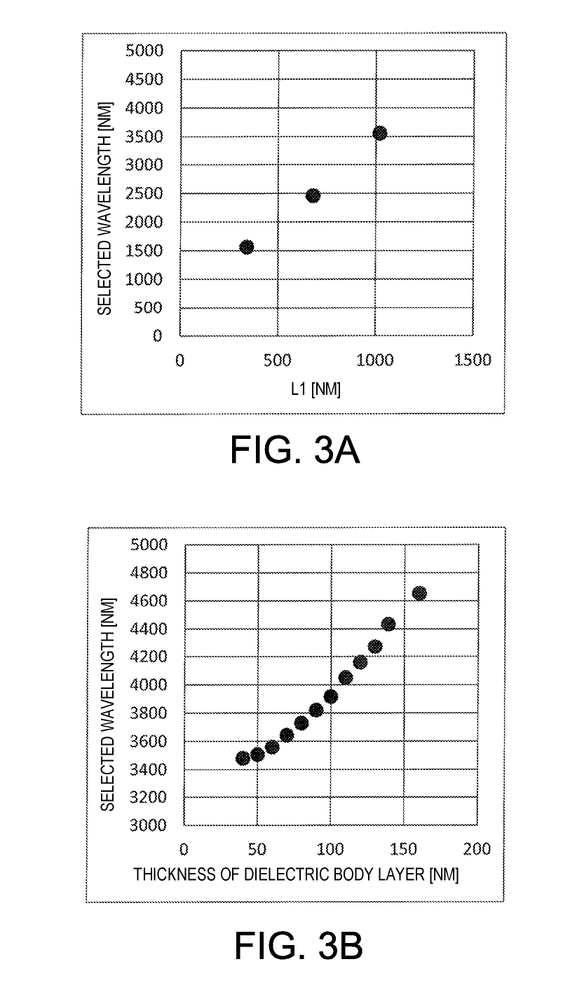

FIG. 3A illustrates a relationship between the difference L1 and the selected wavelength. FIG. 3B illustrates a relationship between the thickness of the dielectric body layer 14 and the selected wavelength. As illustrated in FIGS. 3A and 3B, the selected wavelength depends on the difference L1 and the thickness of the dielectric body layer 14.

The materials forming the respective layers 12 and 14 are not limited to those given above, and may be any materials as long as plasmon resonance occurs at the boundaries of the metal layers 12 with the dielectric body layer 14. Specifically, the material of the metal layer 12 may be any material as long as it has negative permittivity. The refractive index of the dielectric body layer 14 may be any index as long as it is higher than the refractive index (1.4) of the base layer (silicon oxide film) in contact with the metal layer 121. For example, in a case where the metal layer 12 is made from a material with a low refractive index, such as Ag, the wavelength can be selected, not only from the mid-infrared range, but also from the near-infrared range (800 nm to 2,000 nm) or the visible light range (400 nm to 800 nm). In other words, an optical filter in which the selected wavelength is within these wavelength ranges can be achieved.

### Second Embodiment

The selectivity of the wavelength may be increased by using two or more optical filters having different properties from each other. An example of such a case is described as follows.

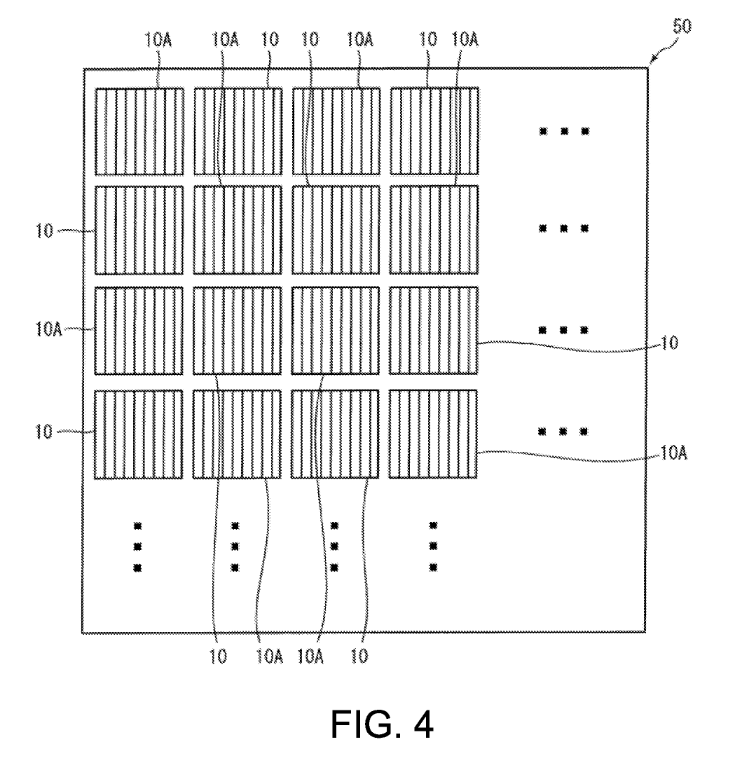

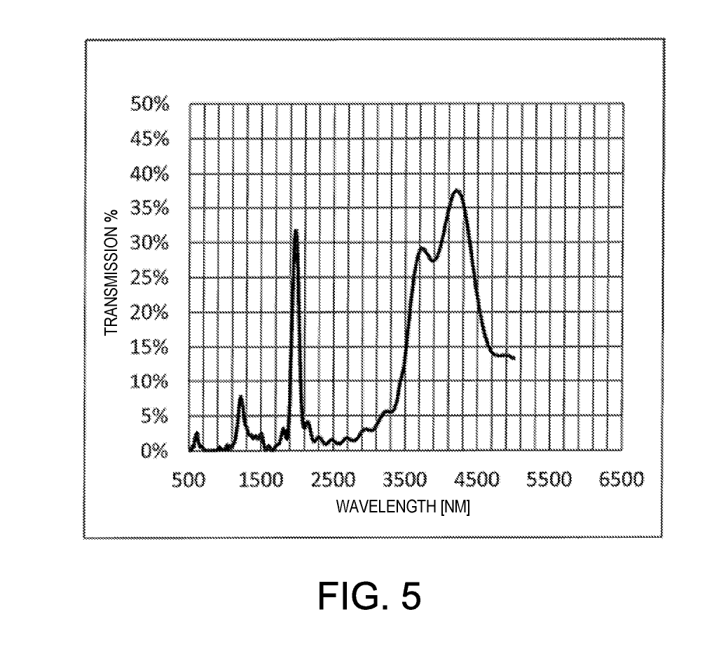

FIG. 4 is an optical filter 50 according to a second embodiment of the present invention. The optical filter 50 has a structure in which optical filters 10A and the optical filters 10 are arranged alternately in column and row directions. The optical filter 10A is the same as the optical filter 10 except for the difference L1. In the optical filter 10A, the difference L1 is 970 nm. The optical filter 10A has a transmission property illustrated in FIG. 5. With the transmission property of the optical filter 10A, the peak is shifted to the shorter wavelength side compared to the transmission property of the optical filter 10. As described above, the difference between the optical filters 10A and 10 is only in the difference L1. Therefore, the optical filter 10A can be manufactured together with the optical filter 10.

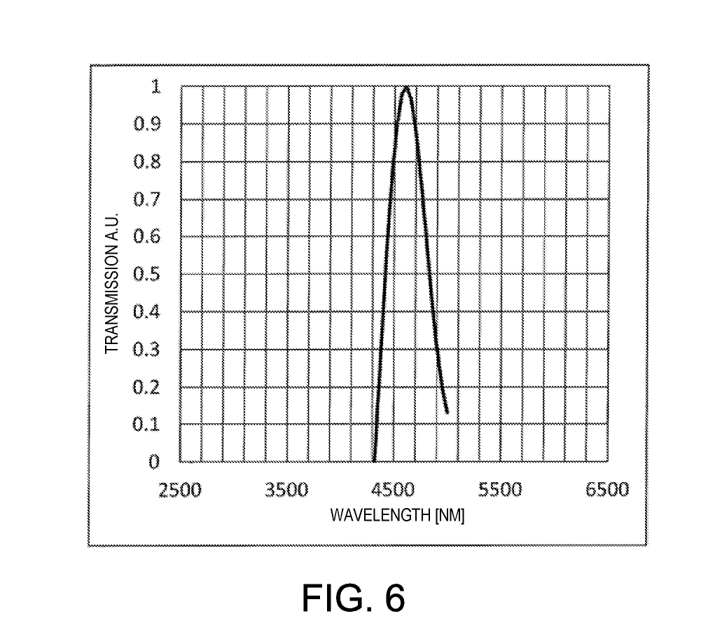

FIG. 6 illustrates a wavelength range detectable by the optical filter 10 but not detectable by the optical filter 10A (hereinafter, referred to as the specific wavelength range). The property illustrated in FIG. 6 is obtained by taking a difference between an output of the optical filter 10 and an output of the optical filter 10A within a wavelength range from 4,000 nm to there-above. The vertical axis of FIG. 6 indicates a ratio of the transmissivity when the transmissivity of the peak is 1. As illustrated in FIG. 6, the specific wavelength range is extremely narrow. Therefore, when the optical filters 10 and 10A function as the band-pass filters, in other words, when the selected wavelength range is narrow, noise (detection of unintentional transmission light caused outside an estimated selected wavelength range) can be reduced to a minimum level because using a plurality of band-pass filters has a lower possibility of detecting unintentional transmission light compared to using a plurality of filters having a wide selected wavelength range (i.e., edge filters). Each of the optical filters 10 and 10A used in the optical filter 50 functions as the band-pass filter. Thus, as described above, the specific wavelength range becomes narrow. As a result, the wavelength selectivity of the optical filter 50 increases.

### Modification of Second Embodiment

The optical filters 10 or the optical filters 10A may be changed to optical filters having a different transmission property. Alternatively, optical filters having a different transmission property may be stacked on top of the optical filters 10 and 10A. Here, the optical filter having the different transmission property may be a filter having a different property from that of the band-pass filter. Such an optical filter is, for example, an edge filter. With an optical filter utilizing plasmon resonance at the boundary between the dielectric body layer and the metal layer (plasmonic filter), any wavelength may be selected without significantly changing the materials forming the metal layer and the dielectric body layer or the manufacturing method. On the other hand, the edge filter has a limited selectivity of the wavelength; however, it has a sharp rising edge. By utilizing these characteristics to mutually complement each other, an optical filter with even higher performance can be achieved.

### Third Embodiment

The optical filter 10 described in the first embodiment functions as the band-pass filter for transmitting light having the wavelength of the mid-infrared range. Optical filters applicable as embodiments of the present invention are not limited to function as the band-pass filter for transmitting light having the wavelength of the mid-infrared range, and may function as a band-pass filter for transmitting light having the wavelength of the near-infrared range (800 nm to 2,000 nm). One example thereof is described as follows.

The example described as follows indicates an optical filter which is used for a water detection sensor. The optical filter transmits light having a wavelength (970 nm) absorbable by water within the near-infrared range. Note that the configuration described as follows is an example. Obviously, various parameters (e.g., the thickness of the metal layer, etc.) are adjustable to transmit light having the wavelength described above.

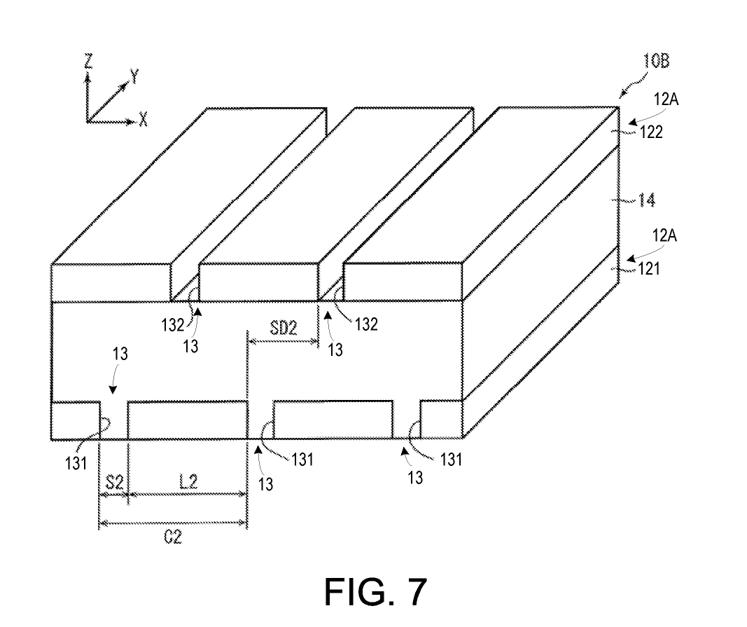

FIG. 7 illustrates an optical filter 10B of a third embodiment of the present invention. The optical filter 10B is different from the optical filter 10 in that a metal layer 12A is provided instead of the metal layer 12.

In this embodiment of the metal layer 121, a cycle C2 of the slit 13 is preferably between 200 nm and 400 nm. In this embodiment, the cycle C2 is 280 nm. A width S2 of the slit 13 is preferably between 50 nm and 150 nm. In this embodiment, the width S2 is 80 nm. In other words, in this embodiment, a difference L2 between the cycle C2 and the width S2 is 200 nm. The width S2 is preferably between 10% and 50% of the cycle C2. In this embodiment, the width S2 is approximately 29% of the cycle C2. An offset width SD2 of the slit 132 from the corresponding slit 131 is preferably between 50 nm and 150 nm. In this embodiment, the offset width SD2 is 60 nm.

The thickness of the dielectric body layer 14 is preferably between 40 nm and 200 nm. In this embodiment, the thickness of the dielectric body layer 14 is 100 nm. The thickness of the metal layer 12A is preferably between 40 nm and 100 nm. In this embodiment, the thickness of the metal layer 12A is the same as that in the first embodiment. The thickness of the dielectric body layer 14 is preferably between 1 to 5 times the thickness of the metal layer 12A. In this embodiment, the thickness of the dielectric body layer 14 is 2.5 times the thickness of the metal layer 12A.

Within the near-infrared range, the refractive index of the dielectric body layer 14 is preferably 1.4 or higher, and more preferably between 1.4 and 3.0. In this embodiment, the material and the refractive index of the dielectric body layer 14 are the same as the first embodiment. Within the near-infrared range, the refractive index of the metal layer 12A is preferably 1.0 or lower, and more preferably between 0.1 and 0.9. In this embodiment, the metal layer 12A is made from Ag. The refractive index of the metal layer 12A is 0.22 for light having a wavelength of 1,000 nm.

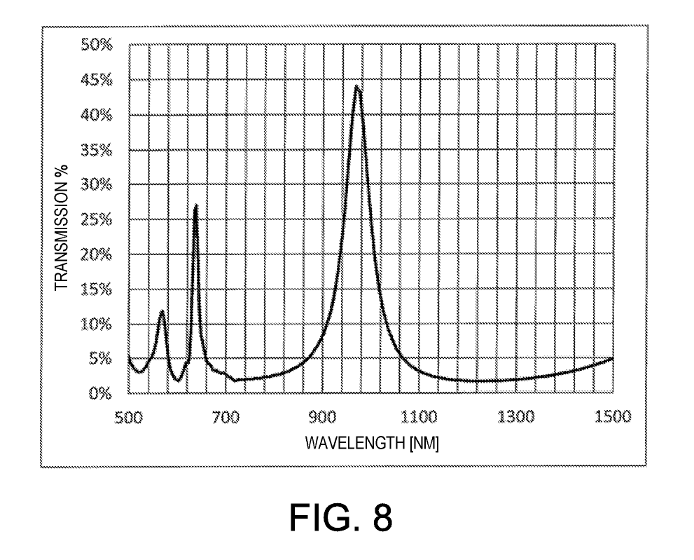

The optical filter 10B has a property illustrated in FIG. 8. As illustrated in FIG. 8, with the optical filter 10B, the wavelength can be selected within the near-infrared range. In other words, the optical filter 10B functions as a band-pass filter for transmitting light having the wavelength of the near-infrared range. As illustrated in FIG. 8, the optical filter 10B has a high peak at 970 nm. Here, the wavelength absorbable by water within the near-infrared range is 970 nm. In other words, the optical filter 10B is a band-pass filter supporting the absorption wavelength of water within the near-infrared range.

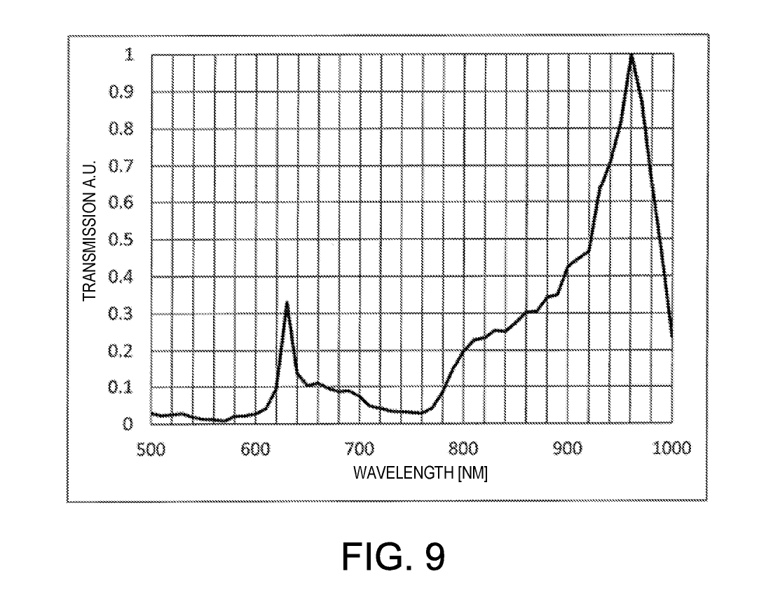

A limit of the wavelength detectable by S1 for use in a CCD image sensor is approximately 1,000 nm. Therefore, to mount the optical filter on the CCD image senor, high wavelength selectivity is required. FIG. 9 illustrates a sensitivity property of a light detector in which the optical filter 10B is disposed on the CCD image sensor and a black filter is disposed on the optical filter 10B. Here, the black filter is a long-pass filter having an edge at 800 nm. As illustrated in FIG. 9, a light detector supporting the absorption wavelength of water can be achieved.

### Fourth Embodiment

In the first embodiment, the optical filter in which the slits 131 do not overlap with the slits 132 when seen from the normal direction of the metal layer 12, and the slits 131 are formed at the same cycle as the slits 132 is described. Optical filters applicable as embodiments of the present invention may be formed with the upper slits at a different cycle from the lower slits as long as the upper slits do not overlap with the lower slits when seen in the normal direction of the metal layer. For example, in a case where a reduction of the half width (FWHM) is desired or an achievement of a multi-band-pass filter of high performance is desired, the upper slits may be formed at a different cycle from the lower slits. One example thereof is described as follows.

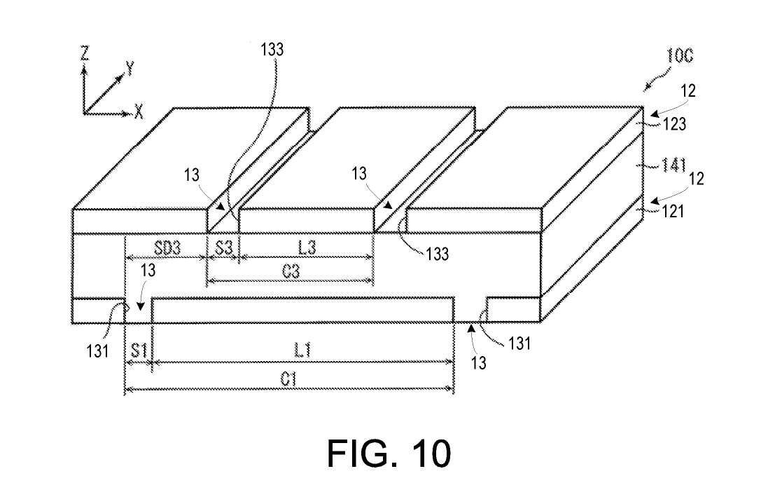

FIG. 10 illustrates an optical filter 10C according to a fourth embodiment of the present invention. The optical filter 10C is different from the optical filter 10 in that a metal layer 123 is provided instead of the metal layer 122, and a dielectric body layer 141 is provided instead of the dielectric body layer 14.

The metal layer 123 is different from the metal layer 122 in that slits 133 are formed instead of the slits 132. A cycle C3 of the slit 133 is 560 nm. In other words, the cycle C3 of the slit 133 is half the cycle C1 of the slit 131. A width S3 of the slit 133 is 100 nm. In other words, a difference L3 between the cycle C3 and the width S3 is 460 nm. An offset width SD3 is 280 nm. The thickness of the metal layer 123 is the same as that of the metal layer 121. Other conditions (e.g., the material and the refractive index) of the metal layer 123 are the same as those of the metal layer 122.

Although the example in which the cycle C1 is twice the cycle C3 is illustrated in FIG. 10, the cycle C1 is not necessary twice the cycle C3. To avoid the overlapping of the slits 131 with the slits 133 when seen in the normal direction of the metal layer 12, the cycle C1 is preferably an integral multiple of the cycle C3.

The dielectric body layer 141 is different from the dielectric body layer 14 in thickness. The thickness of the dielectric body layer 141 is 100 nm. Other conditions (e.g., the material and the refractive index) of the dielectric body layer 141 are the same as those of the dielectric body layer 14.

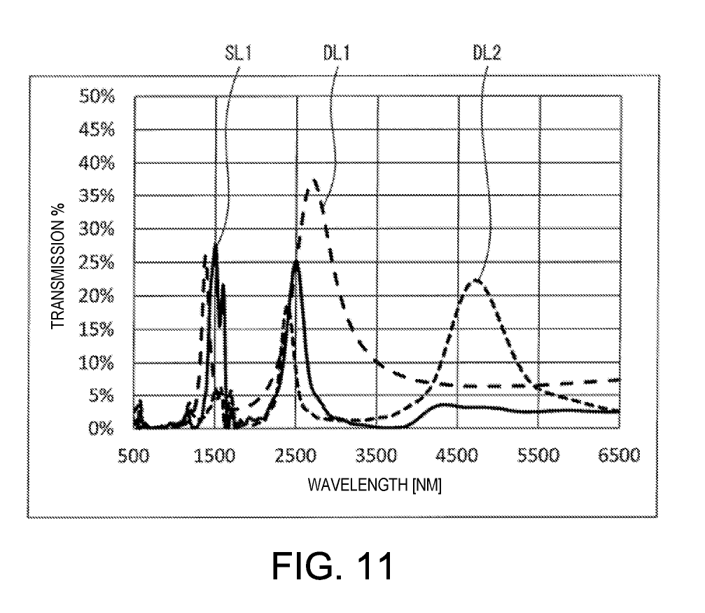

FIG. 11 illustrates transmission properties, in which a relationship between the wavelength of light which enters into the optical filter 10C and transmissivity thereof (transmission property) is indicated by a solid line SL1, and transmission properties of an optical filter in which the upper slits and the lower slits are formed at the same cycle as each other are indicated by dashed lines DL1 and DL2. Under the condition that the cycles of the upper and lower slits are the same, Mode (1) in which the cycles are 560 nm and the width of the slits is 100 nm is indicated by the dashed line DL1, and Mode (2) in which the cycles are 1,120 nm and the width of the slits is 100 nm is indicated by the dashed line DL2. In Mode (1), the offset width between the upper and lower slits is 280 nm. In Mode (2), the offset width between the upper and lower slits is 560 nm. Note that the transmission property of the optical filter in Mode (2) is slightly different from that of the optical filter 10 of the first embodiment because the film thickness of the dielectric body layer is different.

As illustrated in FIG. 11, the optical filter 10C has a different property from Modes (1) and (2) and has a comparatively narrower half width. The reason for the different property, etc., can be assumed to be due to the different cycles of the slits 131 and 133. The following description is given regarding the different property, etc.

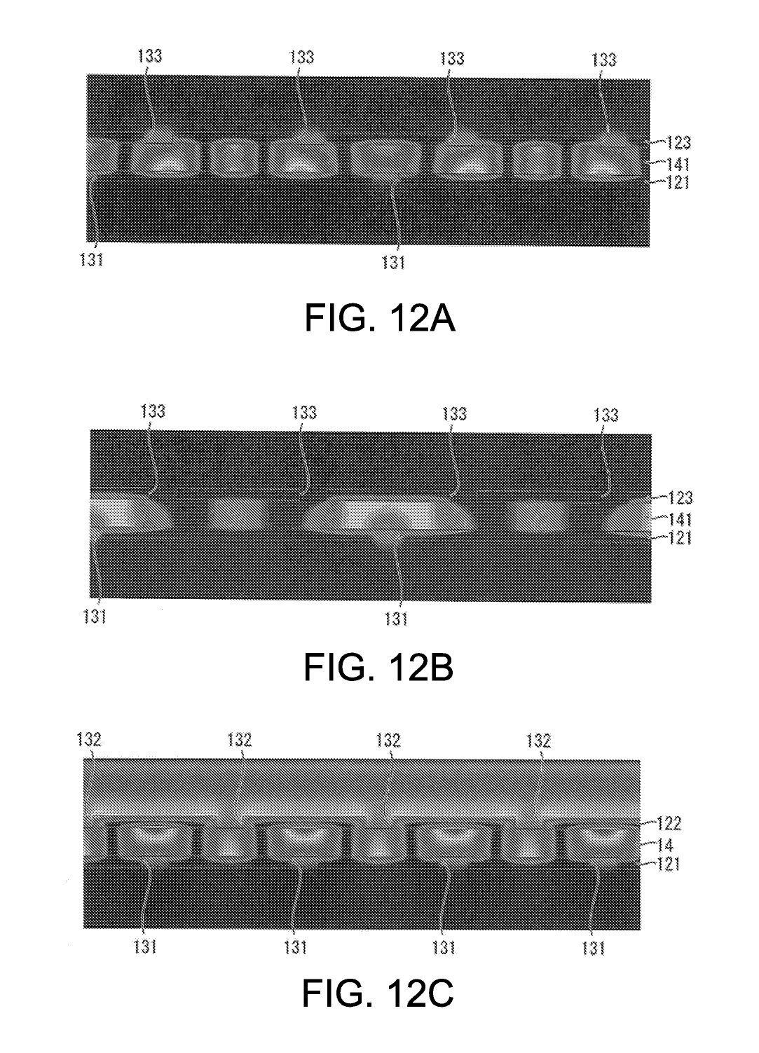

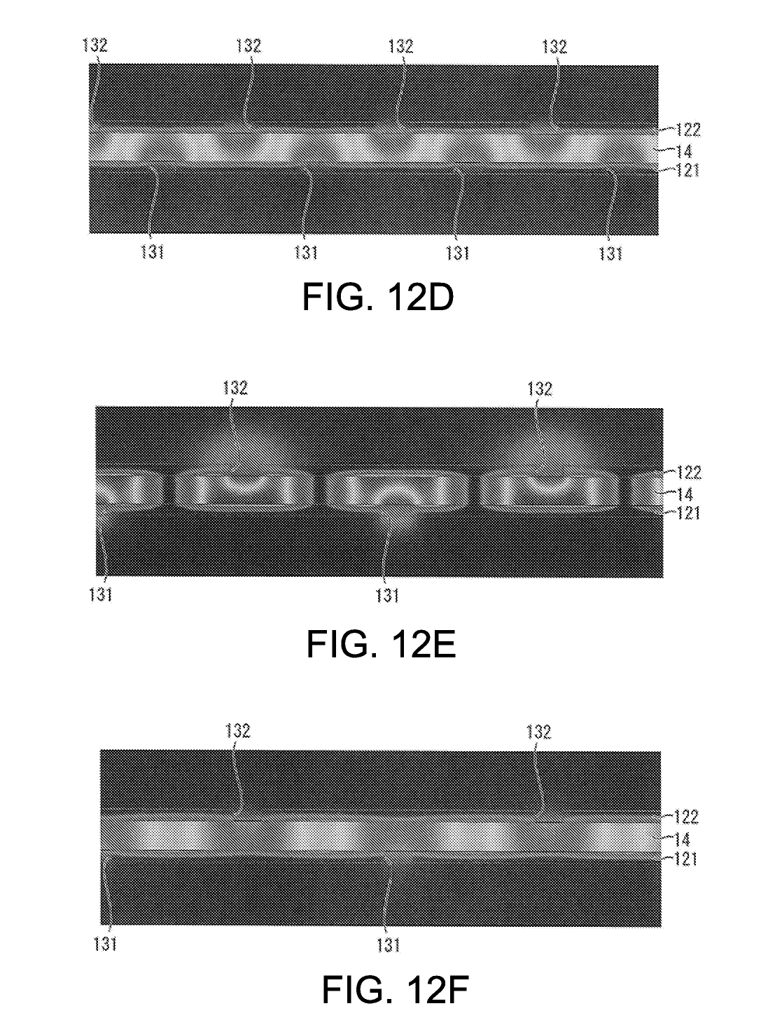

FIG. 12A illustrates a magnetic field distribution in the optical filter 10C in the steady state when light having a wavelength of 1,500 nm enters. FIG. 12B illustrates a magnetic field distribution in the optical filter 10C in the steady state when light having a wavelength of 2,500 nm enters. FIG. 12C illustrates a magnetic field distribution in the optical filter of Mode (1) in the steady state when light having a wavelength of around 1,500 nm enters. FIG. 12D illustrates a magnetic field distribution in the optical filter of Mode (1) in the steady state when light having a wavelength of around 2,500 nm enters. FIG. 12E illustrates a magnetic field distribution in an optical filter of Mode (2) in the steady state when light having a wavelength of around 2,500 nm enters. FIG. 12F illustrates a magnetic field distribution in the optical filter of Mode (2) in the steady state when light having a wavelength of around 4,500 nm enters.

With reference to FIG. 11, the peak at 1,500 nm in the transmission property of the optical filter 10C can be assumed to correspond to the peak around 1,500 nm in the transmission property of the optical filter of Mode (1). In other words, the peak at 1,500 nm in the transmission property of the optical filter 10C can be assumed to be caused by the peak around 1,500 nm in the transmission property of the optical filter of Mode (1). Here, as illustrated in FIGS. 12A and 12C, similar magnetic fields are distributed in the optical filter 10C and the optical filter of Mode (1). In other words, similar resonances occur in the optical filter 10C and the optical filter of Mode (1). Therefore, the assumption made above, specifically, that the peak at 1,500 nm in the transmission property of the optical filter 10C corresponds to the peak around 1,500 nm in the transmission property of the optical filter of Mode (1), can be considered to be appropriate.

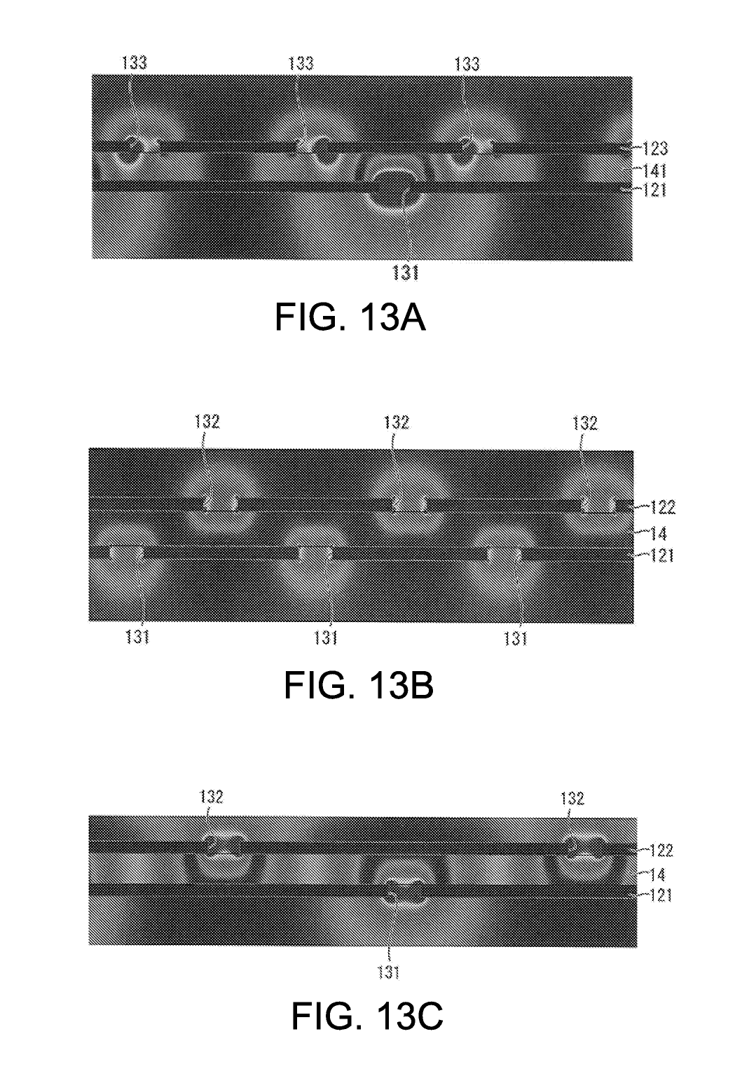

With reference to FIG. 11, the peak at 2,500 nm in the transmission property of the optical filter 10C can be assumed to correspond to the peak around 2,500 nm (a low-order frequency element of the peak around 1,500 nm) in the transmission property of the optical filter of Mode (1) and the peak around 2,500 nm in the transmission property of the optical filter of Mode (2). In other words, the peak at 2,500 nm in the transmission property of the optical filter 10C can be assumed to be caused by the peak around 2,500 nm in the transmission property of the optical filter of Mode (1) and the peak around 2,500 nm in the transmission property of the optical filter of Mode (2). Here, as illustrated in FIGS. 12B, 12D, and 12E, in the optical filter 10C, a magnetic field similar to those of the optical filters of Modes (1) and (2) is distributed. By taking the electric field distributions illustrated in FIGS. 13A, 13B, and 13C into consideration, in the optical filter 10C, resonance having both of the properties of the optical filters of Modes (1) and (2) can be assumed to occur.

With reference to FIG. 11, the peak at 2,500 nm in the transmission property of the optical filter 10C is between the peak around 2,500 nm in the transmission property of the optical filter of Mode (1) and the peak around 2,500 nm in the transmission property of the optical filter of Mode (2). Further, transmissivity at the peak at 2,500 nm in the transmission property of the optical filter 10C is between transmissivity at the peak around 2,500 nm in the transmission property of the optical filter of Mode (1) and transmissivity at the peak around 2,500 nm in the transmission property of the optical filter of Mode (2). Furthermore, a half width of the peak at 2,500 nm in the transmission property of the optical filter 10C is between a half width of the peak around 2,500 nm in the transmission property of the optical filter of Mode (1) and a half width of the peak around 2,500 nm in the transmission property of the optical filter of Mode (2).

Note that the optical filter 10C has almost no peak around 4,500 nm as the optical filter of Mode (2) has, because the magnetic field distribution as illustrated in FIG. 12F never occurs in the optical filter 10C.

### Modification of Fourth Embodiment

In the fourth embodiment, the case where the cycle C1 of the slit 131 of the metal layer 121 is an integral multiple of the cycle C3 of the slit 133 of the metal layer 123 disposed on the entrance side of light with respect to the metal layer 121 is described above; however, the case may be reversed, in other words, the metal layer 123 with the cycle C3 may be disposed on the exit side of light. One example thereof is described as follows.

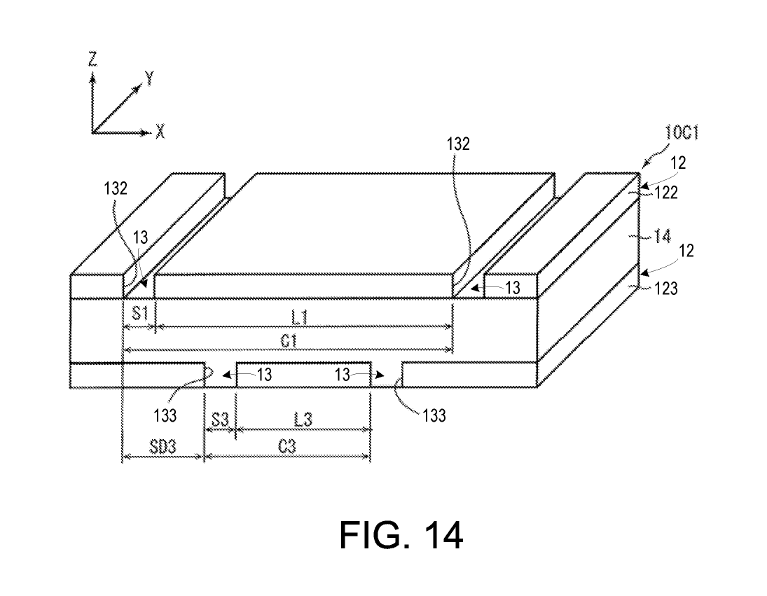

FIG. 14 illustrates an optical filter 10C1 according to a modification of the fourth embodiment of the present invention. The optical filter 10C1 is different from the optical filter 10 in that a metal layer 123 is provided instead of the metal layer 121.

The metal layer 123 is different from the metal layer 121 in that slits 133 are formed instead of the slits 131. The cycle C3 of the slit 133 is 560 nm. In other words, the cycle C3 of the slit 133 is half the cycle C1 of the slit 132. A width S3 of the slit 133 is 100 nm. In other words, a difference L3 between the cycle C3 and the width S3 is 460 nm. An offset width SD3 is 280 nm. The thickness of the metal layer 123 is the same as that of the metal layer 122. Other conditions (e.g., the material and the refractive index) of the metal layer 123 are the same as those of the metal layer 121.

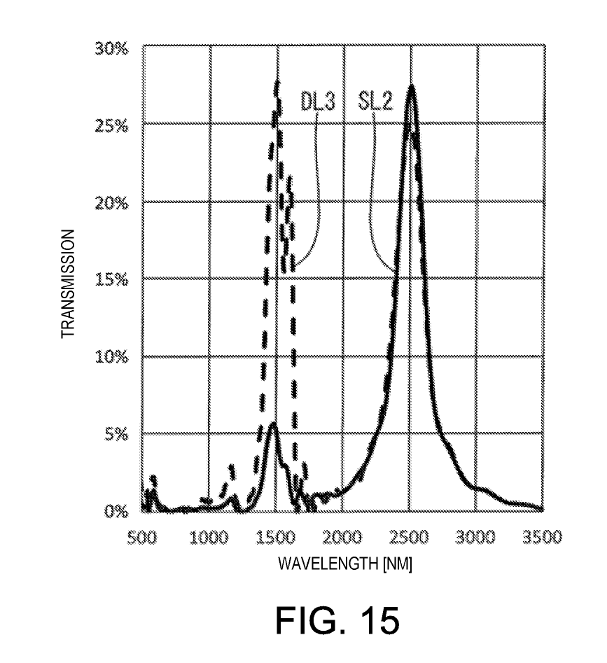

FIG. 15 illustrates transmission properties, in which a relationship between the wavelength of light which enters into the optical filter 10C1 and transmissivity thereof (transmission property) is indicated by a solid line SL2, and the transmission property of the optical filter 10C is indicated by a dashed line DL3. As illustrated in FIG. 15, in the optical filter 10C1, light having a wavelength around 1,500 nm is harder to transmit compared to the optical filter 10C. Thus, the optical filter 10C1 is effective in detecting only light having a wavelength around 2,500 nm.

### Fifth Embodiment

In the second and fourth embodiments, the capability of adjusting the transmission property of the optical filter by suitably setting the cycle of the slit is described. Further, in the third embodiment, the capability of adjusting the transmission property of the optical filter by suitably setting the material of the metal layers is described. Thus, in a fifth embodiment, capability of adjusting the transmission property of the optical filter by suitably setting the refractive index of the dielectric body layer is described.

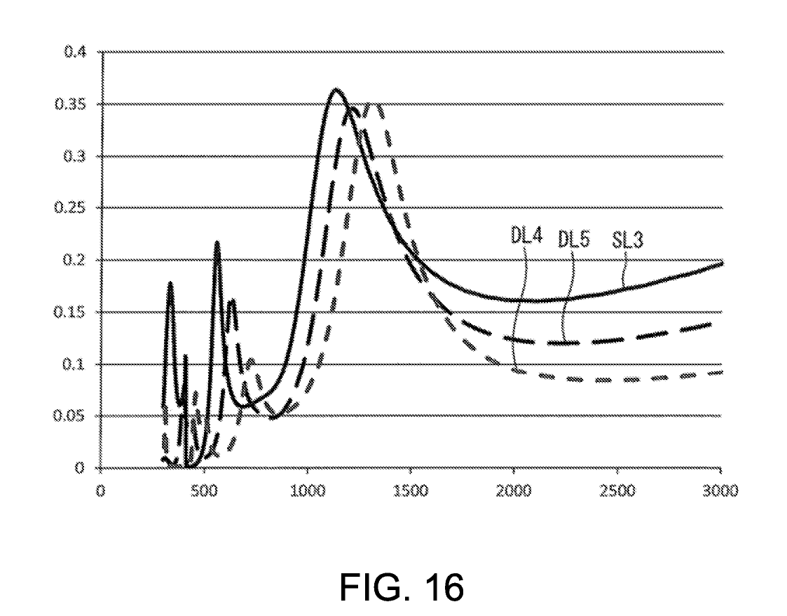

FIG. 16 illustrates a difference in the transmission property when the refractive index of the dielectric body layer is changed. Note that the optical filter used here is the optical filter of FIG. 7 with the thickness of the dielectric body layer changed to 60 nm. The transmission property was examined in cases where the refractive index is 1.95 and 2.78, respectively. The case where the refractive index is 1.95 is indicated by a solid line SL3 and the case where the refractive index is 2.78 is indicated by a dashed line DL4. The refractive index is different even with the same material (SiN) because a temperature and an atmosphere during film formation are changed.

With reference to FIG. 16, it can be understood that even with dielectric body layers made from the same material (SiN), the layer having a higher refractive index tends to have a longer resonance wavelength and a smaller leak on the longer wavelength side of the resonance wavelength. Thus, it can be understood that the resonance wavelength can be adjusted also by suitably setting the refractive index of the dielectric body layer. In other words, it can be understood that the selected wavelength can be adjusted also by suitably setting the refractive index of the dielectric body layer. It can also be understood that in the case of using the dielectric body layer having a comparatively lower refractive index, such as oxide silicon, the leak on the longer wavelength side becomes larger and a property as an edge filter is obtained. Therefore, in this embodiment, the refractive index is preferably 1.4 or higher.

Further, in FIG. 16, a transmission property when a dielectric body layer structured by stacking, on each other, a dielectric body layer having a refractive index of 1.95 and a thickness of 30 nm and a dielectric body layer having a refractive index of 2.78 and a thickness of 30 nm is provided is indicated by a dashed line DL5. With reference to FIG. 16, it can be understood that the transmission property of this case has a resonance wavelength between the resonance wavelength when the refractive index is 1.95 and the resonance wavelength when the refractive index is 2.78. It can also be understood that the leak on the longer wavelength side of the resonance wavelength is between the leak in the case with 1.95 and the leak in the case with 2.78. In other words, it can be understood that the dielectric body layer is not required to have the same refractive index over the entire thickness of the dielectric body layer, and a plurality of dielectric body layers having different refractive indexes may be stacked according to a required property.

### Sixth Embodiment

In the first to fifth embodiments, the optical filters having two metal layers and one dielectric body layer are described. Optical filters applied as embodiments of the present invention utilize a resonance phenomenon caused at the boundary between the metal layer and the dielectric body layer. Therefore, the optical filters applied as embodiments of the present invention may include three or more metal layers. A case of including three metal layers is described as follows.

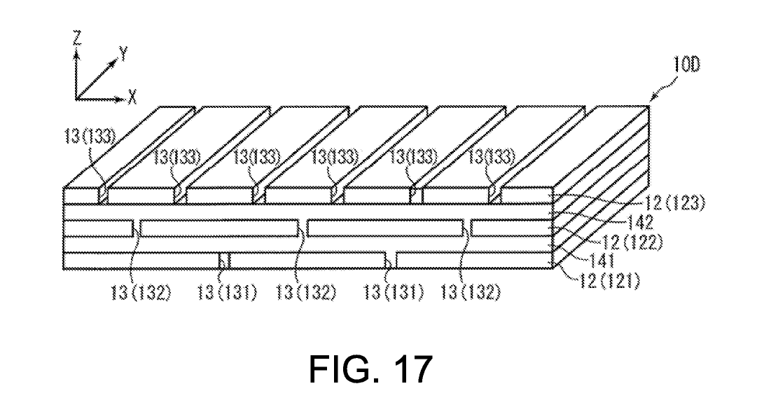

FIG. 17 illustrates an optical filter 10D of a sixth embodiment of the present invention. The optical filter 10D is different from the optical filter 10 in that a dielectric body layer 141 is provided instead of the dielectric body layer 14. The optical filter 10D is different from the optical filter 10 in that a dielectric body layer 142 and a metal layer 123 are also provided. Thicknesses of the dielectric body layers 141 and 142 are 100 nm. The dielectric body layers 141 and 142 are made from SiN. Refractive indexes of the dielectric body layers 141 and 142 are 2.7. Thicknesses of the metal layers 121 to 123 are 40 nm. The metal layers 121 to 123 are made from AlCu. Refractive indexes of the metal layers 121 to 123 are 0.74 for light having a wavelength of 550 nm. The cycles of the slit 131 formed in the metal layer 121 and the slit 132 formed in the metal layer 122 are 1,120 nm. The widths of the slits 131 and 132 are 100 nm. The offset width between the slits 131 and 132 is 560 nm. The cycle of the slit 133 formed in the metal layer 123 is 560 nm. The width of the slit 133 is 100 nm. The offset width between the slits 132 and 133 is 280 nm.

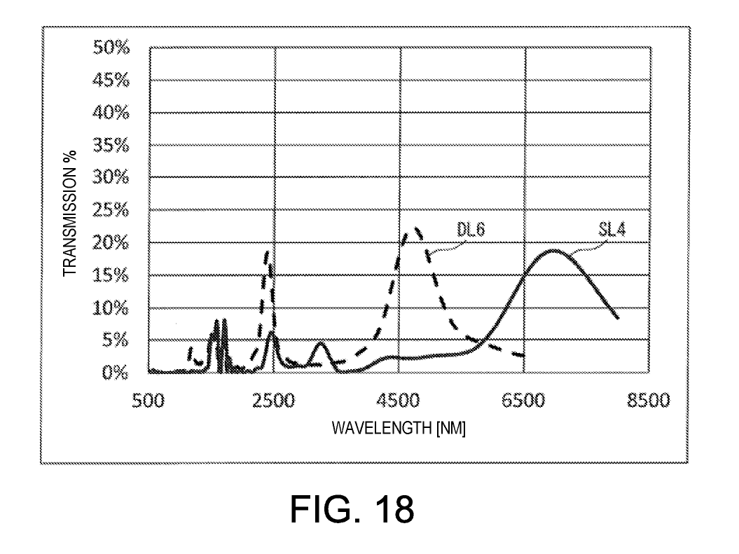

FIG. 18 illustrates a transmission property of the optical filter 10D with a solid line SL4. Further, FIG. 18 illustrates, with a dashed line DL6, a transmission property of an optical filter corresponding to the optical filter of FIG. 17 (optical filter 10D) without the dielectric body layer 142 and the metal layer 123.

With reference to FIG. 18, the optical filter 10D has a different transmission property from that of the optical filter of FIG. 17 (optical filter 10D) without the dielectric body layer 142 and the metal layer 123. Such a difference can be assumed to be caused because the dielectric body layer 142 and the metal layer 123 are provided.

As is apparent form the above embodiments, an optical filter according to a first aspect of the present invention includes a plurality of metal layers and at least one dielectric body layer. The dielectric body layer is disposed between two adjacent metal layers of the plurality of metal layers. Each of the plurality of metal layers is formed with a plurality of slits. The plurality of slits are arranged at an even interval in a predetermined direction. The plurality of slits formed in one of the adjacent metal layers do not overlap with the plurality of slits formed in the other metal layer in a normal direction of the adjacent metal layers.

Although the optical filter according to the first aspect of the present invention has the simple structure, transmissivity of light of a predetermined wavelength range improves. Thus, high transmissivity and a property of mainly transmitting light of the predetermined wavelength range (wavelength selectivity) can both be achieved. As a result, the optical filter can function as a band-pass filter.

An optical filter according to a second aspect of the present invention is the optical filter of the first aspect, in which the one adjacent metal layer includes a first metal layer and a second metal layer. The second metal layer is formed in the same level of layer as the first metal layer and at a different position from the first metal layer. A cycle of the plurality of slits formed in the first metal layer is different from that of the plurality of slits formed in the second metal layer.

In the second aspect, the selectivity of the wavelength can be increased even higher.

An optical filter according to a third aspect of the present invention is the optical filter of one of the first and second aspects, in which the cycle of the plurality of slits formed in the one adjacent metal layer is different from that of the plurality of slits formed in the other metal layer.

In the third aspect, the selectivity of the wavelength can be increased even higher.

An optical filter according to a fourth aspect of the present invention is the optical filter of the third aspect, in which the cycle of the plurality of slits formed in the one adjacent metal layer is an integral multiple of that of the plurality of slits formed in the other metal layer.

In the fourth aspect, the selectivity of the wavelength can be increased even higher.

An optical filter according to a fifth aspect of the present invention is the optical filter of the fourth aspect, in which the one adjacent metal layer is disposed on an entrance side of light with respect to the other metal layer. The cycle of the plurality of slits formed in the one adjacent metal layer is shorter than that of the plurality of slits formed in the other metal layer.

In the fifth aspect, the selectivity of the wavelength can be increased even higher.

An optical filter according to a sixth aspect of the present invention is the optical filter of the fourth aspect, in which the one adjacent metal layer is disposed on an entrance side of light with respect to the other metal layer. The cycle of the plurality of slits formed in the other metal layer is shorter than that of the plurality of slits formed in the one adjacent metal layer.

In the sixth aspect, the selectivity of the wavelength can be increased even higher.

Although the preferred embodiments of the present invention are described above, these embodiments are merely instantiations, and the present invention is not to be limited by the above embodiments in any form.

### LIST OF REFERENCE CHARACTERS

10 Optical Filter

12 Metal Layer

13 Slit

14 Dielectric Body Layer

1. An optical filter, comprising:
a plurality of metal layers; and
a dielectric body layer disposed between two adjacent metal layers of the plurality of metal layers,
wherein each of the plurality of metal layers is formed with a plurality of slits at an even interval in a predetermined direction, and the plurality of slits formed in one of the adjacent metal layers do not overlap with the plurality of slits formed in the other of the adjacent metal layers in a normal direction of the adjacent metal layers.

2. The optical filter of claim 1, wherein the one adjacent metal layer includes:
a first metal layer; and
a second metal layer formed in the same layer level as the first metal layer and at a different position from the first metal layer, and
wherein a cycle of a plurality of slits formed in the first metal layer is different from that of a plurality of slits formed in the second metal layer.

3. The optical filter of claim 1, wherein a cycle of the plurality of slits formed in the one adjacent metal layer is different from that of the plurality of slits formed in the other metal layer.

4. The optical filter of claim 3, wherein the cycle of the plurality of slits formed in the one adjacent metal layer is an integral multiple of that of the plurality of slits formed in the other metal layer.

5. The optical filter of claim 4, wherein the one adjacent metal layer is disposed on an entrance side of light with respect to the other metal layer, and
wherein the cycle of the plurality of slits formed in the one adjacent metal layer is shorter than that of the plurality of slits formed in the other metal layer.

6. The optical filter of claim 4, wherein the one adjacent metal layer is disposed on an entrance side of light with respect to the other metal layer, and
wherein the cycle of the plurality of slits formed in the other metal layer is shorter than that of the plurality of slits formed in the one adjacent metal layer.
